(19) United States
(12) Patent Application Publication
(10) Pub. No.: US 2013/0103581 A1
(43) Pub. Date: Apr. 25, 2013

(54) SYSTEMS AND METHODS FOR SINGLE NUMBER PAN VIRTUAL/PHYSICAL CARD

(71) Applicants: Richard BARRY, (US); Govind Bajaj, Chennai (IN); Louis Steve Biafore, La Jolla, CA (US); Karthikeyan Gnanamani, Chennai (IN); Shiv Charan Sastry, Chennai (IN)

(72) Inventors: Richard BARRY, (US); Govind Bajaj, Chennai (IN); Louis Steve Biafore, La Jolla, CA (US); Karthikeyan Gnanamani, Chennai (IN); Shiv Charan Sastry, Chennai (IN)

(21) Appl. No.: 13/280,763

(22) Filed: Oct. 25, 2011

(51) Int. Cl. G06Q 40/00

(52) U.S. Cl. 705/42; 705/35

(57) ABSTRACT

A credit/debit card that can be utilized as a virtual card or as a physical card. The system provides a single PAN (Primary Account Number) for both the virtual and the physical card so that they represent a single account. The customer can elect one of the card formats. When one format is selected, the other format is inactive. In one embodiment, the customer can toggle back and forth between formats. To distinguish between the types of card, each card has modulated non-PAN data. For example, the expiration date on each card may be modified so that uses of the card will be recognized as coming from one format or the other.

### BACKGROUND OF THE SYSTEM

1. Technical Field

This application relates to the field of debit cards and credit transactions.

2. Related Art

Credit and debit cards have become standard methods for accomplishing financial transactions and interchanges. In many transactions (e.g. car rental), having some sort of card or electronic account representing available credit is required to complete a transaction. Therefore it is important for consumers to be able to have a financial card in the modern world. A credit card is a card that allows a consumer to have access to credit for financial transactions, typically up to some predefined limit, without needing to have that amount on hand prior to the transaction. A debit card is a card that represents money that is actually in the possession of the consumer or holder of the card, such as in an associated bank account or in some manner electronically loaded onto the debit card itself.

A problem arises for consumers who are “un-banked” or are in some manner uncreditworthy. Such customers may find it difficult or even impossible to qualify for a credit card. These customers can obtain a debit card, but the card represents their own money (as opposed to loaned credit) and has many disadvantages. One disadvantage is that in return for offering the convenience of a debit card, the issuer charges fees for its use and other circumstances. For example, their may be a monthly fee, a fee to use an ATM to withdraw cash from the debit card, a fee for each transaction or purchase, and/or fees to a merchant who accepts the debit card for payment.

Another disadvantage of a debit card is that a user who wants to make a purchase with the card may be forced to wait until the physical card arrives in the mail, and is then activated, before the consumer can use the debit card. This prevents many consumers from acting quickly on desirable opportunities because of the lack of availability of the physical card.

Another disadvantage of prior systems is the need for a consumer to choose between a virtual account and a physical (card based) account. Currently, provision of a physical card for an individual with a virtual account requires opening a new account, with a new/different PAN (card number), transferring all funds/activity from the virtual account to the physical account and closing the original virtual account.

### SUMMARY

A credit/debit card that can be utilized as a virtual card or as a physical card. The system provides a single PAN (Primary Account Number) for both the virtual and the physical card so that they represent a single account. The customer can elect one of the card formats. When one format is selected, the other format is inactive. In one embodiment, the customer can toggle back and forth between formats. To distinguish between the types of card, each card has modulated non-PAN data. For example, the expiration date on each card may be modified so that uses of the card will be recognized as coming from one format or the other.

### BRIEF DESCRIPTION OF THE DRAWINGS

Features, aspects, and embodiments are described in conjunction with the attached drawings, in which:

FIG. 1 is a flow diagram illustrating the creation of an account in one embodiment of the system.

FIG. 2 is a flow diagram illustrating the generation of a virtual card in one embodiment of the system.

FIG. 3 is a flow diagram illustrating the request for a physical card in one embodiment of the system.

FIG. 4 is a flow diagram illustrating the activation of a physical card in one embodiment of the system.

FIG. 5 is a flow diagram illustrating the generation of modulated non-PAN data in one embodiment of the system.

FIG. 6 is a flow diagram illustrating the use of a card in one embodiment of the system.

FIG. 7 is a block diagram of an example computer embodiment of the system.

### DETAILED DESCRIPTION OF THE SYSTEM

This system enables consumers to hold a multi-variant payment-card account (including credit, debit and prepaid debit) with a single PAN (Primary Account Number) wherein the consumer may select at any time which variant they prefer (variants including physical card, virtual card, mobile phone payment, etc.) and activate that variant (deactivating all other variants) in a way such that the consumer's account, regardless of variant, has the same PAN. This allows for unique conveniences such as immediate issue of a virtual prepaid account that becomes live upon issue of the account, followed by activation of physical card once the physical card is manufactured and delivered to the consumer. This allows the consumer to enjoy the benefits of each variant (in the example, the immediate (rapid) availability of the virtual card and the eventual ability to perform functions that require a physical card (ATM transactions, offline purchase, etc.) once the consumer receives and activates the physical card.

Prior to this system, consumers who wanted to enjoy the benefits of different account variants (such as the virtual/physical prepaid card example above) had to accept each variant with a different PAN.

The system allows the use of a single PAN, and enables consumers to gain the benefits of different account variants where each variant has different characteristic benefits and limitations. The system allows the consumer to, at a specific point in time after the virtual account is live, receive, activate and use a specific variant (for example, physical card) with the same PAN as the currently active variant (example: virtual account). The system ensures the security of the account continuously from issue of the initial account variant selected by the consumer through activation of any available variant that the consumer selects. The system enables arbitrary sequences of consumer-selected variants wherein the selected variant is activated and all other variants are deactivated. The system uses a mechanism that involves the modulation of non-PAN card information (details) to ensure that account variants can be distinguished from each other and that only one of the variants can be live at any given point in time.

One embodiment includes: 1) Identification of specific non-PAN data used to distinguish the virtual and physical accounts (including expiration date and/or CSC); 2) A mechanism that makes the values of the distinguishing data difficult to predict (for example, modulation of expiration date and/or difference in expiration length between virtual and physical accounts); and 3) A mechanism that ensures that one and only one of the original virtual and physical account remains “live” at any given time. This includes a process by which the activation and de-activation transactions are monolithic (either both parts completing or both parts failing) and that the span of time between completion of deactivation and completion of activation is very brief (on the order of, for example, seconds or even a sub-second).

Initiation

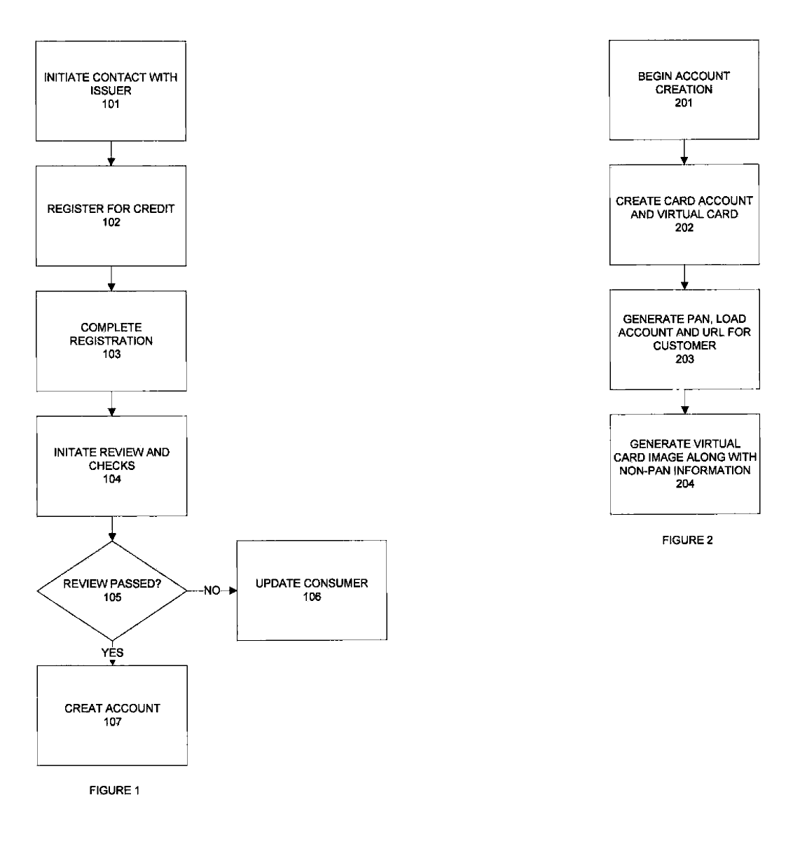

FIG. 1 is a flow diagram illustrating the initiation of the system in one embodiment. At step 101 a consumer initiates contact with an account issuer. This contact may be via a network such as the interne, and involves visiting the website of an issuer. This contact could also be via telephone, in-person visit, via email, or any other suitable manner of communication with an issuer. The term issuer herein refers to a provider of credit, loans, or other financial instruments that can be used with the present system. Examples include banks, credit unions, merchants, savings and loans, government programs, and other entities.

At step 102 the consumer registers for credit. This involves selecting from one or more credit plans and offers from the issuer. The credit may be a loan, it may be an installment based purchase plan, or some other type of credit. In one embodiment, the credit may be for a specific purchase (e.g. automobile, appliance, electronics, etc.) that can be made in a physical store and/or on-line and the user is seeking credit or financing that can be available while the consumer is searching for a desirable version or price on the specific item. In other embodiments, the credit is more open-ended and is not to any specific item.

At step 103 the consumer completes the registration. This may be via an online form or by some other method of application. In one embodiment, the system may utilize a structured reference credit system such as described in U.S. patent application Ser. No. 12/167,962 entitled Systems and Methods For Making Structured Reference Credit Decisions assigned to the assignee of the present application and incorporated by reference herein in its entirety.

At step 104 the system receives the application and performs a review and checks on the application. This may involve acquiring relevant credit data, such as credit bureau reports, proof of employment, and the like, or it may involve the structured reference credit system described above. At decision block 105 it is determined if the consumer application has passed the review. If not, the consumer is updated at step 106. This step may involve asking for additional information from the consumer, offering different terms, or a denial of credit.

If the review is passed at decision block 105, the system proceeds to step 107 and an account is created for the consumer. This process is described below.

Account Generation

FIG. 2 is a flow diagram illustrating a method of account generation in an embodiment of the system. This activity is invoked when a customer has been approved for an account. At step 201 the system begins the account generation. This includes generating a unique user name, linking the consumer's email address to the account, creating log-in protocols (e.g. passwords permissions, and the like) and other card issue instructions.

At step 202 the system creates a card account for the user and issues a virtual card. This is done so that the user can access the account as a virtual card while waiting the creation and acquisition of a physical card representing the account. At step 203 the system generates the single PAN that will be associated with the account, loads the account with the agreed upon funds and/or credit, and creates a URL for the virtual card that can be used by the consumer.

At step 204 the system generates a virtual card image that will be associated with the PAN and the account, along with non-PAN information (expiration date, CSC, and/or other non-PAN information that can be used to easily distinguish the virtual card from an eventually issued physical card). The system then notifies the consumer of the account and URL information. In one embodiment, the CSC/CVV information is sent as a separate communication, such as via SMS to a registered mobile number of the consumer. At this point the virtual card is active and can be used by the consumer in any transaction that will accept a virtual card.

It should be noted that the virtual card may be represented on the web, it may be a displayed image on a smart phone that can be detected by a merchant or machine (e.g. ATM), it may be a bar code image, VR image or some other readable iconography that can be used to represent or be associated with the consumer PAN. It may be the PAN itself.

It should also be noted that at account creation, a customer may elect a physical card and be willing to wait on the generation and transmission of the card to the customer. In such a situation, a virtual card is not created.

Physical Card Creation

FIG. 3 is a flow diagram illustrating the election of, and implementation of issuing, a physical card in one embodiment of the system. As step 301 the virtual card is active. This means that the user has already completed the steps of FIGS. 1 and 2 and has an active account with the issuer.

At decision block 302 it is determined if the user has requested a physical card. This can take place at any time while the virtual account is active. This may be accomplished via the web, via an email request, via telephone, by indicating a request at the account URL, via text, or via any other suitable method.

If the user has not requested a physical card, the system returns to step 301 and the virtual account remains active. If the user has requested a physical card, the system proceeds to step 303. At step 303 the request for the physical card is forwarded to the system. This could be at the issuer itself or a third party approved for fulfillment of requests.

At step 304 the physical card provider creates card data including the PAN associated with the virtual account. The card also modulates the non-PAN data so that the system can distinguish between the virtual card and the physical card even though the PAN is identical. The physical card is then created and is released to the registered address of the requester at step 305.

It should be noted that the virtual account remains active even after the creation of the physical card. In one embodiment, it is only after the physical card has been activated that the virtual account is deactivated.

Physical Card Activation

After the customer has received the physical card, it must be activated before it can be used. Until it is activated, the virtual card remains active. After the physical card is activated, the virtual account is made inactive. (Please note that the physical card can still be used for on-line transactions in cases where a credit/debit card can be used).

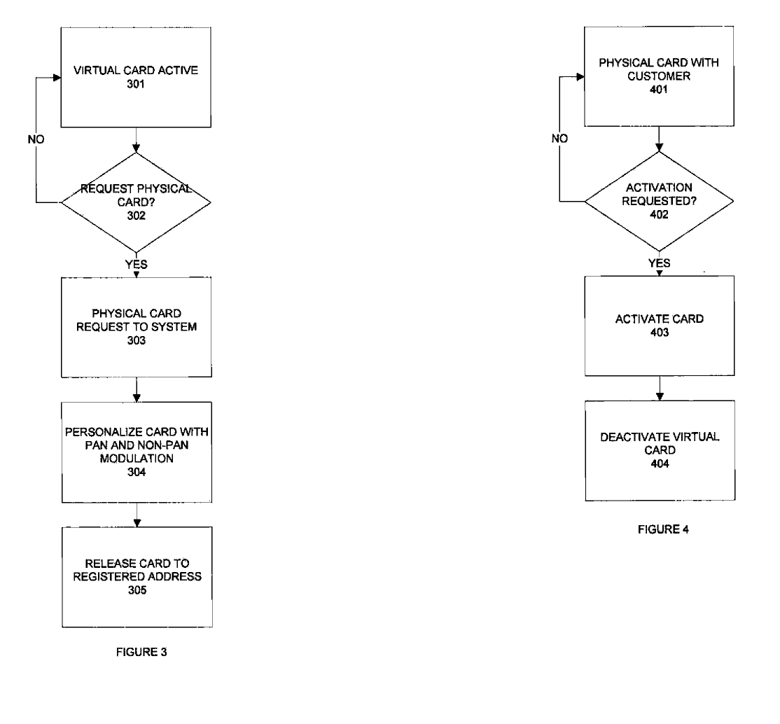

FIG. 4 is a flow diagram illustrating the operation of activating the physical card in one embodiment of the system. At step 401 the physical card is with the customer. This means that the customer has already requested a physical card (such as in the example of FIG. 3) and the card has been sent to the registered address of the customer. In another embodiment, the customer may have a previously activated card that the customer elected to deactivate.

At decision block 402 it is determined if the customer has requested activation of the physical card. This may be via email, text, on-line, or via telephone activation request. If the consumer has not requested activation, the system returns to step 401 and nothing changes with the account. If the consumer has requested activation at step 402, the system proceeds to step 403 and activates the card. The activated card, as noted above, has the same PAN and in fact is the same account of the consumer. The non-PAN information is modulated so that the system can identify if charges are being made from the physical card or the virtual card.

At step 404 the virtual card is deactivated. In one embodiment this happens within seconds of the activation of the physical card.

Non-PAN Modulation

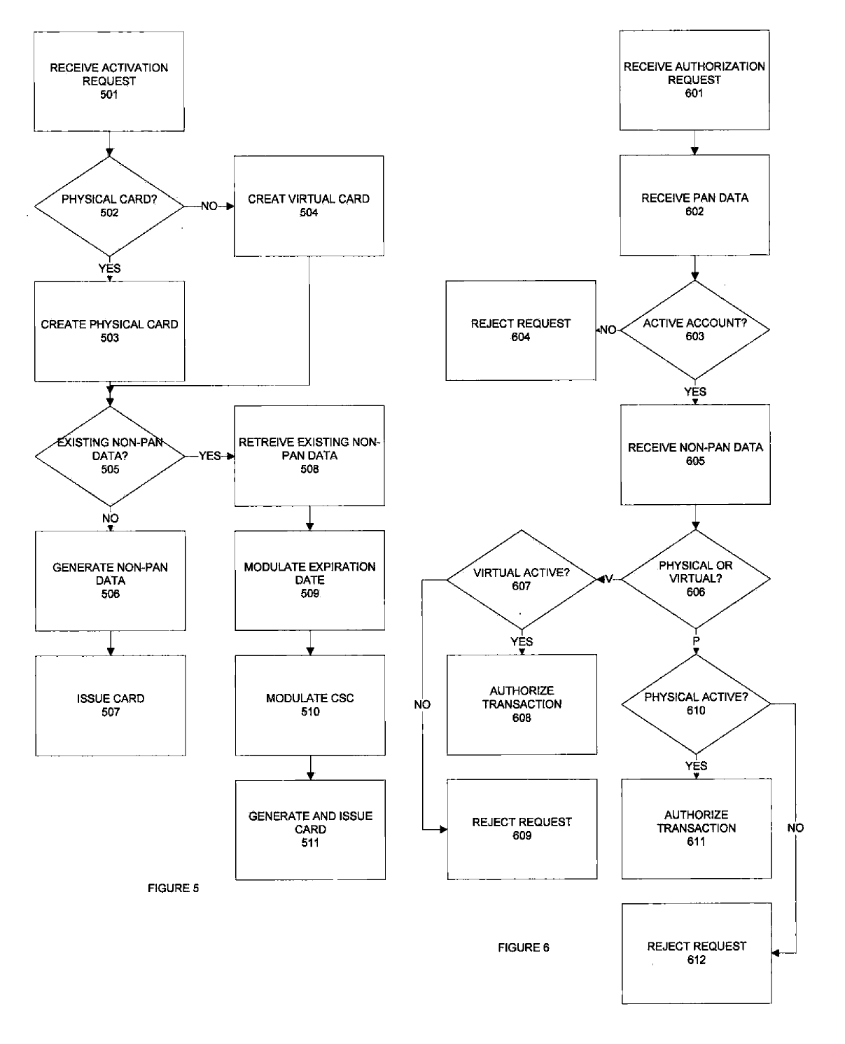

As noted above, the non-PAN information for a virtual or physical card is modulated to distinguish the use of each card. This also allows the system to identify the attempted use of deactivated cards and to prevent the acceptance of charges on deactivated cards. FIG. 5 is a flow diagram illustrating the generation of modulated non-PAN data on a card associated with an account.

At step 501, the system receives a request for activation of an card. This may be for a physical card (when a virtual account already exists or upon initial account creation) or for a virtual card (when switching from a physical card or upon account creation). At decision block 502 it is determined if the activation is for a physical card. If so, the system proceeds to step 503 and creates a physical card. If not, the system proceeds to step 504 and creates a virtual card.

After step 503 or 504, the system proceeds to decision block 505 to determine if non-PAN data for the unelected card already exists. That is, if a physical card is being activated, does non-PAN data already exist for the virtual card. Correspondingly, if a virtual card is being activated, does the physical card already have non-PAN data. If not, the system proceeds to step 506 and generates non-PAN data and issues the card at step 507.

If non-PAN data does already exist at step 505, the system must create modulated non-PAN data for the card to be activated. At step 508, the system retrieves the existing non-PAN data. At step 509 the system modulates the expiration date of the card to be activated so that it is different than the existing expiration date. In one embodiment, this is accomplished by incrementing the expiration month to the next succeeding month. It should be noted that any other scheme that results in a different expiration date can be utilized without departing from the scope and spirit of the system.

At step 510 the system modulates the existing CSC (card security code) and applies it to the card to be activated. This can involve a number of methods. In one embodiment, the system uses even CSC numbers for physical cards and odd CSC numbers for virtual cards. So that the final number of the CSC can be changed from even to the next odd or vice-versa. In another embodiment, the CSC for a physical card has a certain number of digits (e.g. four) and the CSC for a virtual card has greater or fewer digits (e.g. three or five). In this manner, it is possible for the system to discriminate between physical cards and virtual cards having the same PAN. (It should be noted, that in one embodiment only the expiration date or the CSC is modulated, not both).

At step 511 the new card is generated and provided to the registered customer. When the card activation replaces a prior card, the prior card is deactivated.

Card Use

FIG. 6 is a flow diagram illustrating an embodiment of card use in the system. At step 601 the system receives a request for authorization from an attempted card use. At step 602 the system receives the PAN from the transaction processing location. This could be an ATM, a point-of-sale card processor, a merchant, and on-line merchant, and the like. At decision block 603 it is determined if the PAN is an active account. If not, the transaction request is rejected at step 604.

If the PAN is for an active account at decision block 603, the system proceeds to step 605 and receives non-PAN information. At decision block 606 the system determines if the non-PAN information is for a physical card or a virtual card. In one embodiment, the system can determine if the non-Pan information is for a virtual card or a physical card by looking at certain indicators such as number of integers in the CSC, odd or even numbers ending the CDS or expiration date, and the like. In other embodiments, the system refers to a look-up table or some other suitable determining method.

If the non-PAN information is for a virtual card, the system then checks at decision block 607 to determine if the virtual card is active. If so, the system authorizes the transaction at step 608. If not, the system rejects the transaction request at step 609. This condition represents an attempted use of a version of the account that is currently inactive.

If the non-PAN information represents a physical card at decision block 606, the system proceeds to decision block 610 to determine if the physical card is active. If so, the system authorizes the transaction at step 611. If the physical card is not active, the transaction is rejected at step 612.

Embodiment of Computer Execution Environment (Hardware)

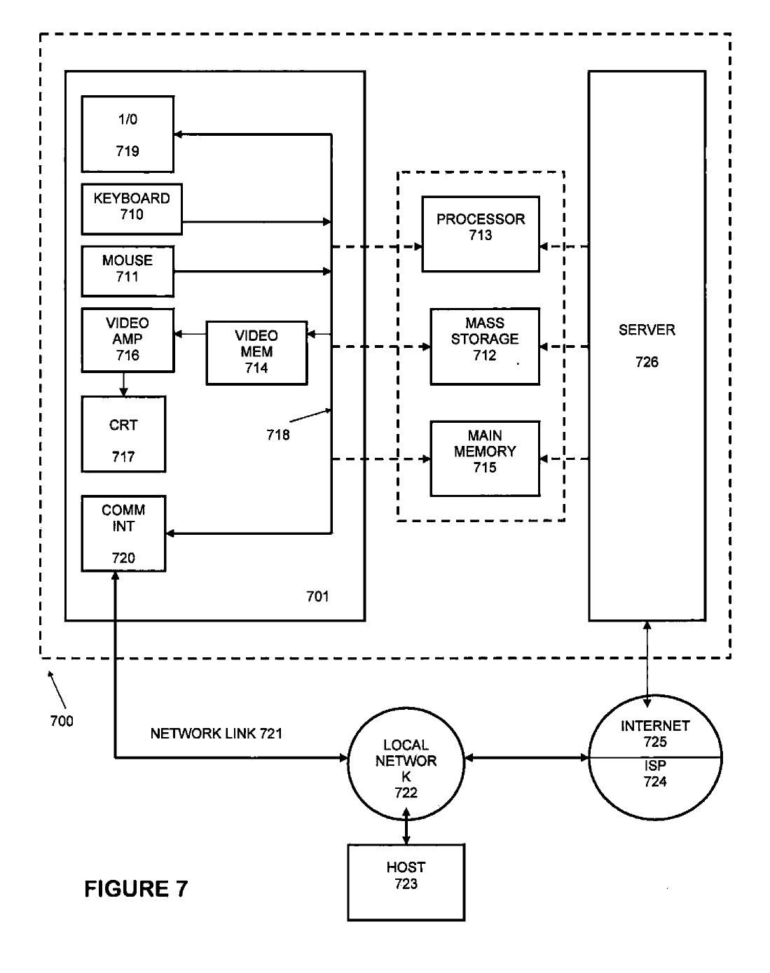

An embodiment of the system can be implemented as computer software in the form of computer readable program code executed in a general purpose computing environment such as environment 700 illustrated in FIG. 7, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 710 and mouse 711 are coupled to a system bus 718. The keyboard and mouse are for introducing user input to the computer system and communicating that user input to central processing unit (CPU 713. Other suitable input devices may be used in addition to, or in place of, the mouse 711 and keyboard 710. I/O (input/output) unit 719 coupled to bi-directional system bus 718 represents such I/O elements as a printer, A/V (audio/video) I/O, etc.

Computer 701 may include a communication interface 720 coupled to bus 718. Communication interface 720 provides a two-way data communication coupling via a network link 721 to a local network 722. For example, if communication interface 720 is an integrated services digital network (ISDN) card or a modem, communication interface 720 provides a data communication connection to the corresponding type of telephone line, which comprises part of network link 721. If communication interface 720 is a local area network (LAN) card, communication interface 720 provides a data communication connection via network link 721 to a compatible LAN. Wireless links are also possible. In any such implementation, communication interface 720 sends and receives electrical, electromagnetic or optical signals which carry digital data streams representing various types of information.

Network link 721 typically provides data communication through one or more networks to other data devices. For example, network link 721 may provide a connection through local network 722 to local server computer 723 or to data equipment operated by ISP 724. ISP 724 in turn provides data communication services through the world wide packet data communication network now commonly referred to as the “Internet” 725 Local network 722 and Internet 725 both use electrical, electromagnetic or optical signals which carry digital data streams. The signals through the various networks and the signals on network link 721 and through communication interface 720, which carry the digital data to and from computer 700, are exemplary forms of carrier waves transporting the information.

Processor 713 may reside wholly on client computer 701 or wholly on server 726 or processor 713 may have its computational power distributed between computer 701 and server 726. Server 726 symbolically is represented in FIG. 7 as one unit, but server 726 can also be distributed between multiple “tiers”. In one embodiment, server 726 comprises a middle and back tier where application logic executes in the middle tier and persistent data is obtained in the back tier. In the case where processor 713 resides wholly on server 726, the results of the computations performed by processor 713 are transmitted to computer 701 via Internet 725, Internet Service Provider (ISP) 724, local network 722 and communication interface 720. In this way, computer 701 is able to display the results of the computation to a user in the form of output.

Computer 701 includes a video memory 714, main memory 715 and mass storage 712, all coupled to bi-directional system bus 718 along with keyboard 710, mouse 711 and processor 713.

As with processor 713, in various computing environments, main memory 715 and mass storage 712, can reside wholly on server 726 or computer 701, or they may be distributed between the two. Examples of systems where processor 713, main memory 715, and mass storage 712 are distributed between computer 701 and server 726 include thin-client computing architectures and other personal digital assistants, Internet ready cellular phones and other Internet computing devices, and in platform independent computing environments,

The mass storage 712 may include both fixed and removable media, such as magnetic, optical or magnetic optical storage systems or any other available mass storage technology. The mass storage may be implemented as a RAID array or any other suitable storage means. Bus 718 may contain, for example, thirty-two address lines for addressing video memory 714 or main memory 715. The system bus 718 also includes, for example, a 32-bit data bus for transferring data between and among the components, such as processor 713, main memory 715, video memory 714 and mass storage 712. Alternatively, multiplex data/address lines may be used instead of separate data and address lines.

In one embodiment of the invention, the processor 713 is a microprocessor such as manufactured by Intel, AMD, Sun, etc. However, any other suitable microprocessor or microcomputer may be utilized, including a cloud computing solution. Main memory 715 is comprised of dynamic random access memory (DRAM). Video memory 714 is a dual-ported video random access memory. One port of the video memory 714 is coupled to video amplifier 719. The video amplifier 719 is used to drive the cathode ray tube (CRT) raster monitor 717. Video amplifier 719 is well known in the art and may be implemented by any suitable apparatus. This circuitry converts pixel data stored in video memory 714 to a raster signal suitable for use by monitor 717. Monitor 717 is a type of monitor suitable for displaying graphic images.

Computer 701 can send messages and receive data, including program code, through the network(s), network link 721, and communication interface 720. In the Internet example, remote server computer 726 might transmit a requested code for an application program through Internet 725, ISP 724, local network 722 and communication interface 720. The received code maybe executed by processor 713 as it is received, and/or stored in mass storage 712, or other non-volatile storage for later execution. The storage may be local or cloud storage. In this manner, computer 700 may obtain application code in the form of a carrier wave. Alternatively, remote server computer 726 may execute applications using processor 713, and utilize mass storage 712, and/or video memory 715. The results of the execution at server 726 are then transmitted through Internet 725, ISP 724, local network 722 and communication interface 720. In this example, computer 701 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

1. A method of providing a payment card comprising:
using a processing system;
creating an account having a primary account number;
issuing a first instantiation of a card associated with the primary account number and generating first non-primary account number data associated with the first instantiation; and
issuing a second instantiation of a card associated with the primary account number, generating second non-primary account number data associated with the second instantiation, and changing the second non-primary account number data to indicate that the second non-primary account number data represents the second instantiation of the card and wherein the second non-primary account number data is different from the first non-primary account number data.

2. The method of claim 1 wherein the first instantiation is a virtual card.

3. The method of claim 2 wherein the second instantiation is a physical card.

4. The method of claim 3 wherein when the virtual card is active the physical card is inactive.

5. The method of claim 4 wherein when the physical card is active the virtual card is inactive.

6. The method of claim 5 wherein the virtual card comprises a mobile phone payment method.

7. The method of claim 5 wherein non-primary account number data comprises an expiration date of the a payment card.

8. The method of claim 7 wherein non-primary account number data comprises a card security code (CSC) of the a payment card.

9. The method of claim 8 wherein the non-primary account number data of a physical card has identifying characteristics.

10. The method of claim 9 wherein the non-primary account number data of a virtual card has identifying characteristics.

11. The method of claim 7, wherein changing the second non-primary account number data further comprises incrementing an expiration month of the expiration date of the card.

12. The method of claim 8, wherein changing the second non-primary account number data further comprises changing the card security code of the card.

13. The method of claim 1 further comprising deactivating the first instantiation of the card when the second instantiation of the card is issued.
